(19) United States
(12) Patent Application Publication
(10) Pub. No.: US 2008/0172828 A1
(43) Pub. Date: Jul. 24, 2008

(54) Method of cleaning carpet comprising melamine foam

(76) Inventor: Jeffrey Lee Butterbaugh, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 12/009,692

(22) Filed: Jan. 22, 2008

Related U.S. Application Data
(60) Provisional application No. 60/881,755, filed on Jan. 22, 2007.

(51) Int. Cl. B43L 19/00; B08B 7/00

(52) U.S. Cl. 15/424; 134/42

(57) ABSTRACT

A method of cleaning a carpet stain comprising: optionally treating the carpet stain with a carpet cleaner, rubbing the carpet stain optionally treated with the carpet cleaner with a cleaning implement, and optionally removing a residual from the carpet.

### CROSS REFERENCE TO RELATED APPLICATION

This application claims the benefit of U.S. Provisional Application No. 60/881,755, filed Jan. 22, 2007.

### TECHNICAL FIELD

The present invention relates to a carpet stain implement comprising of at least one layer of melamine foam.

### BACKGROUND OF THE INVENTION

Melamine-formaldehyde resin foams, also referred to herein as melamine foams, are well known in the art for use in industrial applications, for example, as heat or sound insulating materials as well as for fire protection purposes. Indeed, in the automotive industry, melamine foam is commonly used to insulate motor compartments and driver cabins of cars and trucks.

Recently, a novel application for such melamine foams in the area of hard surface cleaning has been discovered. Indeed, cleaning implements of cut or molded pieces of melamine foam have become popular to remove soils and/or stains from hard surfaces (i.e., cleaning of hard surfaces) such as tiles, walls, floors, sanitary fittings such as sinks, showers, shower curtains, wash basins, WCs, household appliances including, but not limited to, refrigerators, freezers, washing machines, automatic dryers, ovens, microwave ovens, dishwashers and so on. Indeed, melamine foam sponges are currently marketed under the tradename Mr. Clean Magic Eraser®. In order to stabilise the melamine foam and to prevent early break-up of it, sponges combining melamine foam and a stabilising material, such as a rigid polyurethane have been proposed and marketed (sold under the tradename Scotch Brite Easy Erasing Pad® by 3M Corp.). Melamine foam pieces combined with or laminated to a second material are known in the art, for example; from US 2001/0024720 or JP 2001-258809.

While melamine foams have been used successfully to clean hard surfaces, other surfaces have presented cleaning challenges. Surfaces such as carpet have provided unique cleaning challenges for melamine as melamine has a tendency to crumble. Because of this tendency to crumble, it has not been applied toward carpet cleaning.

It is therefore, an objective of the present invention to provide a method of cleaning surfaces, such as carpets, utilizing a melamine foam.

### SUMMARY OF THE INVENTION

In a first aspect, there is a method of cleaning a carpet stain comprising: optionally treating the carpet stain with a carpet cleaner, rubbing the carpet stain optionally treated with the carpet cleaner with a cleaning implement, and optionally removing a residual from the carpet.

### DETAILED DESCRIPTION OF THE INVENTION

While the specification concludes with the claims particularly pointing and distinctly claiming the invention, it is believed that the present invention will be better understood from the following description.

The devices, apparatuses, methods, components, and/or compositions of the present invention can include, consist essentially of, or consist of, the components of the present invention as well as other ingredients described herein. As used herein, “consisting essentially of” means that the devices, apparatuses, methods, components, and/or compositions may include additional ingredients, but only if the additional ingredients do not materially alter the basic and novel characteristics of the claimed devices, apparatuses, methods, components, and/or compositions.

All percentages and ratios used herein are by weight of the total composition and all measurements made are at 25° C., unless otherwise designated. A degree is a planar unit of angular measure equal in magnitude to 1/360 of a complete revolution. When possible, an angle is measured between the outer edge of the inner facing surface and the vertex, whereby the outer edge is located is distally located from the vertex.

All measurements used herein are in metric units unless otherwise specified.

It has now been surprisingly discovered that the method of using the cleaning implement of the present invention, used optionally with a carpet cleaner, produces improved cleaning efficiency. The method of the present invention includes optionally treating the carpet stain with a carpet cleaner, rubbing the carpet stain optionally treated with the carpet cleaner with a cleaning implement, and optionally removing a residual from the carpet.

Without wishing to be bound by theory, it is believed that the cleaning implement provides unexpected cleaning results when compared with a cloth towel, paper towel, or the like. It is believed that this improved cleaning is the result of maximizing the mechanical abrasion of the melamine foam. This improved cleaning efficiency is achieved by 1) cleaning through microscopic mechanisms to penetrate the surface asperities, 2) cleaning through macroscopic surface conformation to maximize surface contact and 3) liquid action, including lubrication of the melamine and dirt transport away from the surface to be cleaned.

### Cleaning Method

The method of cleaning of the present invention includes optionally treating the carpet stain with a carpet cleaner. The optional treating includes applying spray carpet cleaners, foaming cleaners, granule carpet cleaners, surfactant systems, and the like. The optional treating can be performed with in any way readily known to one of ordinary skill including aerosol and non-aerosol spraying, brushing in, sprit sing, and the like. Any method of applying a carpet cleaner to carpet known in the art is herein contemplated.

After or concurrent with the treating the carpet stain with a carpet cleaner, the present invention includes rubbing the carpet stain treated with the carpet cleaner with a cleaning implement. In one embodiment, the rubbing step comprises rubbing in a circular motion. In another embodiment, the rubbing step comprises an up and down motion. In yet another embodiment, the rubbing step comprises a blotting or wicking motion. In another embodiment, the rubbing step begins outside of the stain work toward about the middle of the stain. In still another embodiment, the rubbing step begins at the center of the stain and works radically out toward the edge of the stain. The embodiments of the rubbing step are selected based upon the type of stain, carpet, and optional carpet cleaner used for the present method.

Upon completion of the rubbing step, the present invention includes optionally removing a residual from the carpet. The residual of the present invention includes any material left in the carpet after the rubbing step that can be removed using physical processes such as sweeping, whisking, vacuuming, and the like. The residual includes soils, loose soils and dirt, and any materials that may make up the carpet stain. The residual of the present invention may also include particles and/or portions of the cleaning implement that remain on or in the carpet after the rubbing step.

### Cleaning Implement

The cleaning implement herein comprises at least one layer of melamine. The cleaning implement may also include multiple layers of melamine. Where there are multiple layers of melamine, the layers of melamine can have the same physical dimensions or different dimensions. Moreover, the melamine layers can have the same physical parameters or varying parameters. It is also contemplated that cleaning implement can contain non-melamine layers in combination with the at least one layer of melamine. Non-limiting non-melamine layers include scouring materials or a scouring pads, rigid foam materials, a handle made of thermoplastic material, wood, metal or combinations thereof, and the like.

The layers of the cleaning implement according to the present invention may cover each other either partially or fully. By a “partial coverage” it is meant that at least one of the layers overlaps the other layer (or other layers, if any) and is not fully covered by said other layer (or other layers, if any). By a “full coverage” it is meant that the layers of the cleaning implement do fully cover each other and that none of the layers substantially overlap the other layer (or other layers, if any).

By a “cleaning implement” it is meant herein an article of manufacture of any suitable shape and/or size and/or volume suitable for cleaning, i.e., removing spots and/or stains from carpet. The cleaning implement herein is in a shape and/or size and/or volume suitable for use by a consumer to clean hard surfaces therewith. Suitable shapes of the cleaning implements herein may be selected from: cube shape, rectangular shape, pyramid shape, cylindrical shape, cone shape, pencil eraser shape, cuboid shape, tetrahedron shape; sphere shape; globular shape; and ellipsoid shape. Other shapes not specifically listed here may also be suitable for use, as would be known by one of ordinary skill in the art.

Suitable volumes of the cleaning implements herein may be from about 1 cm³ to about 10,000 cm³, in another embodiment from about 10 cm³ to about 1,000 cm³, in another embodiment from about 150 cm³ to about 250 cm³, in another embodiment from about 50 cm³ to about 400 cm³, in another embodiment from about 80 cm³ to about 300 cm³, in another embodiment from about 150 cm³ to about 275 cm³, in another embodiment from about 200 cm³ to about 250 cm³.

In one embodiment the volume of melamine has a leading edge. Without wishing to be bound by theory, it is believed that the leading edge allows a user to more efficiently transfer force though the block. In one embodiment, the leading edge is at least about 3 mm, in another embodiment at least about 6 mm, in another embodiment, at least about 18 mm, in another embodiment at least about 29 mm in another embodiment at least about 3 mm to about 29 mm, in another embodiment at least about 6 to about 18 mm. The leading edge is formed at the intersection of two planes where the angle of intersection is between about 45° and about 135°.

In another embodiment herein, the cleaning implement herein has a cuboid shape defined by three groups of parallel and equal length sides, referred to as a, b and c, wherein a ranges from about 20 mm to about 200 mm, in another embodiment from about 40 mm to about 80 mm, b ranges from about 20 mm to about 200 mm in another embodiment from about 80 mm to about 150 mm, and c ranges from about 15 mm to about 5 cm, in another embodiment from about 20 mm to about 40 mm for any shape configuration in one embodiment the thickness is at least 1 mm, in another embodiment 10 mm, in another 15 mm.

In another embodiment herein the cleaning implement herein is in the shape of a pencil eraser. By “shape of a pencil eraser” it is meant herein a voluminous body having six walls, wherein three pairs of parallel and equally shaped and sized walls exist and wherein one pair of walls are in the shape of a parallelogram and the remaining two pairs of walls are of rectangular shape.

### Melamine Foam

By “melamine” or “melamine foam” it is meant herein a melamine-formaldehyde resin foam. By “thickness” it is meant herein, the length in mm of the side having the smallest extension compared to other sides of the melamine foam layer (the height of the melamine foam layer). In case the cleaning implement is based on a rectangular shape and the melamine foam layer extends in parallel to the sides of the shape having the largest surface area (extensions in the x and y axis), the thickness can be referred to as the extension in the direction of the y axis. In case the cleaning implement is based on an irregular shape and/or the extension of the thickness of the melamine foam layer varies (i.e., the layer is thicker in some parts of the implement as compared to others), it is sufficient that at least once the thickness of the melamine foam layer extends over the thickness required herein.

A suitable melamine-formaldehyde resin foam raw material is commercially available under the trade name Basotect® from BASF.

The melamine foam of the current invention has a Rockwell hardness of between about 100 M to about 150 M, in another embodiment from about 115 M to about 125 M.

The melamine foam described above can be prepared by blending major starting materials of melamine and formaldehyde, or a precursor thereof, with a blowing agent, a catalyst and an emulsifier, injecting the resultant mixture into a mold, and making the reaction mixture generate heat through a proper means such as heating or irradiation with electromagnetic wave to cause foaming and curing. The molar ratio of melamine to formaldehyde (i.e., melamine: formaldehyde) for producing the precursor is preferably 1:1.5 to 1:4, particularly preferably 1:2 to 1:3.5 in melamine: formaldehyde. In addition, number average molecular weight of the precursor is preferably 200 to 1,000, particularly preferably 200 to 400. Additionally, formalin, which is an aqueous solution of formaldehyde, is usually used as formaldehyde.

As monomers for producing the precursor, the following various monomers may be used in an amount of 50 parts by weight (hereinafter abbreviated as “parts”) or less, particularly 20 parts by weight or less, per 100 parts by weight of the sum of melamine and formaldehyde in addition to melamine and formaldehyde. As other monomers corresponding to melamine, there may be used C1-5 alkyl-substituted melamines such as methylolmelamine, methylmethylolmelamine and methylbutylolmelamine, urea, urethane, carbonic acid amides, dicyandiamide, guanidine, sulfurylamides, sulphonic acid amides, aliphatic amines, phenols and the derivatives thereof. As aldehydes, there may be used acetaldehyde, trimethylol acetaldehyde, acrolein, benzaldehyde, furfurol, glyoxal, phthalaldehyde, terephthalaldehyde, etc.

As the blowing agent, there may be used pentane, trichlorofluoromethane, trichlorotrifluoroethane, etc. However, use of so-called fleons® such as trichlorofluoromethane is regulated from the point of view of environmental problems, thus not being preferred. On the other hand, pentane is preferred in that it easily provides a foam when used even in a small amount but, since it has a volatile flammability, it requires sufficient care in its handling. Further, as the catalyst, formic acid is commonly used and, as the emulsifier, anionic surfactants such as sodium sulfonate may be used.

The amount of the electromagnetic wave to be irradiated for accelerating the curing reaction of the reaction mixtures is preferably adjusted to be 500 to 1,000 kW, particularly 600 to 800 kW, in electric power consumption based on 1 kg of an aqueous formaldehyde solution charged in the mold. In case when this electric power consumption is insufficient, there results an insufficient foaming, leading to production of a cured product with a high density. On the other hand, in case when the electric power consumption is excessive, the pressure upon foaming becomes seriously high, leading to serious exhaustion of the mold and even the possibility of explosion. Thus, electric power consumption outside the range is not preferred.

The melamine of the present invention, in one embodiment, is present as a foam. The surface of the foam comprises cells. In one embodiment, these cells have a diameter from about 1 μm to about 20 μm, in another embodiment from about 5 μm to about 10 μm.

### Carpet Cleaner

The melamine of the present invention may, optionally, be utilized with a carpet cleaner. In one embodiment, the carpet cleaner is an aqueous carpet cleaner. Aerosol and non-aerosol carpet cleaners are also contemplated. Carpet cleaners of the present invention may also include solvents, surfactants, perfumes, stabilizers, structurants, lubricants, and the like. One of ordinary skill would readily know how to formulate a carpet cleaner to be utilized in the present invention.

### Carpet Cleaning Kit

The method of the present invention can be performed with a kit containing the carpet cleaning implement and the carpet cleaner. In one embodiment the kit of the present invention is packaged and/or sold together with no additional items. In another embodiment, the kit of the present invention is packaged with at least one additional carpet cleaning implement. In a non-limiting example, the kit of the present invention is packaged and/or sold with a vacuum or a quick carpet cleaning device, such as the device disclosed by U.S. Ser. No. 11/179,247 filed Jul. 12, 2005.

The kit of this invention may be packaged by any suitable means known to package cleaning implements. Indeed, particularly suitable packaging means herein are selected from: paper bags, plastic bags, cartons, carton boxes, flow wraps, plastic wraps, and paper wraps, and the like and combinations thereof.

The packaging means herein may be printed and/or modified. In particular, such printing and/or other modification may be used to associate a brand-name and/or logo of a hard surface cleaner with said cleaning implement.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

As used herein, “essentially free of” is defined as containing only trace amounts. In one embodiment, this amount is less than about 1%, alternatively less than about 0.5%, alternatively less than about 0.1%, alternatively less than about 0.01%.

As used herein, “and/or” is defined as any combination of one or more elements of the specified set. For example, A and/or B is to be interpreted as either A, B, or A and B. Except as otherwise noted, the articles “a,” “an,” and “the” mean “one or more.”

What is claimed is:

1. A method of cleaning a carpet stain comprising: optionally treating the carpet stain with a carpet cleaner, rubbing the carpet stain optionally treated with the carpet cleaner with a cleaning implement, and optionally removing a residual from the carpet.

2. The method of claim 1, wherein the implement has at least one layer of melamine foam further comprises a thickness of at least 15 mm.

3. The method of claim 1, said cleaning implement further comprising a leading edge having a length of at least about 3 mm.

4. The method of claim 1, wherein the cleaning implement further comprises a shape selected from: cube shape, rectangular shape, pyramid shape, cylindrical shape, cone shape, pencil eraser shape, cuboid shape, and tetrahedron shape.

5. The method of claim 1, wherein the cleaning implement further comprises a volume of from 1 cm³ to 10,000 cm³.

6. The method of claim 1, wherein said melamine foam is a melamine-formaldehyde resin foam.
